(19) United States
(12) Patent Application Publication
(10) Pub. No.: US 2004/0216103 A1
(43) Pub. Date: Oct. 28, 2004

(54) Mechanism for detecting and handling a starvation of a thread in a multithreading processor environment

(75) Inventors: William Elton Burky, Austin, TX (US); Ronald Nick Kalla, Round Rock, TX (US)

Correspondence Address: Robert A. Voigt, Jr., 5400 Renaissance Tower, 1201 Elm Street, Dallas, TX, 75270, US

(73) Assignee: International Business Machines Corporation, Armonk, NY

(21) Appl. No.: 10/422,656

(22) Filed: Apr. 24, 2003

(51) Int. Cl. G06F 9/46

(52) U.S. Cl. 718/100

(57) ABSTRACT

A method and multithread processor for detecting and handling the starvation of a thread. A counter associated with a first thread may be set with a pre-selected value. The counter may be updated in response to receiving a notification. The notification may indicate which, if any, group of instructions has been completed for the first and second threads. The counter may be updated in response to receiving the notification by decrementing a current value stored in the counter if the group of instructions is completed for the second thread and not for the first thread. If the value of the counter reaches a predetermined value, then a thread starvation condition may be detected for the first thread. That is, if the value of the counter reaches the predetermined value, then the first thread may be starved.

### TECHNICAL FIELD

The present invention relates to the field of multithreading processors, and more particularly to a mechanism for detecting and handling a starvation of a thread in a multithreading processor environment.

### BACKGROUND INFORMATION

Modern processors employed in computer systems use various techniques to improve their performance. One of these techniques is commonly referred to as “multithreading.” Multithreading allows multiple streams of instructions, commonly referred to as “threads,” to be executed. The threads may be independent programs or related execution streams of a single parallel program or both.

Processors may support three types of multithreading. The first is commonly referred to as “coarse-grained” or “block multithreading.” Coarse-grained or block multithreading may refer to rapid switching of threads on long-latency operations. The second is commonly referred to as “fine-grained multithreading.” Fine-grained multithreading may refer to rapid switching of the threads on a cycle by cycle basis. The third type of multithreading is commonly referred to as “simultaneous multithreading.” Simultaneous multithreading may refer to scheduling of instructions from multiple threads within a single cycle.

In modern processors, including simultaneous multithreading (SMT) processors, a condition commonly referred to as a “thread starvation” may occur. A thread may be said to be “starved” in the context of an SMT processor when one thread cannot make forward progress because of an inability of using a resource being used exclusively by another thread(s).

The current techniques for detecting and handling a starvation of a thread usually involve a counter counting the number of cycles from the last instruction executed for the thread starved. If the number exceeds a threshold, then a starvation of a thread may be assumed. Typically, the threshold is extremely high, such as on the order of a million cycles, to ensure that a thread starvation condition is not incorrectly identified such as identifying the fetching of an instruction from memory after a cache miss as a thread starvation condition. Further, the current recovery methods for a thread being starved usually involve a flush of all of the stored instructions for all threads and to refetch the instruction causing the thread starvation condition. These techniques for detecting thread starvation conditions are too slow. Further, flushing of all instructions should be avoided if at all possible.

Therefore, there is a need in the art to effectively detect and handle thread starvation conditions in a simultaneous multithreading (SMT) processor by detecting thread starvation conditions earlier than current detection techniques and avoiding the flushing of all instructions in a recovery action.

### SUMMARY

The problems outlined above may at least in part be solved in some embodiments by setting a counter associated with a first thread with a pre-selected value. The value stored in the counter may be updated in response to receiving a notification. The notification may indicate which, if any, group of instructions has been completed for the first or second thread. That is, the notification may indicate that a group of instruction has been completed for both the first and second threads. The notification may also indicate that a group of instruction has been completed for either the first or second thread. The notification may also indicate that no group of instructions has been completed for either the first or second thread. If the notification indicates that a group of instructions has been completed for the second thread and not for the first thread, then the value in the counter may be decremented by a value of “1.” If the value of the counter reaches a predetermined value, then a thread starvation condition may be detected for the first thread. That is, if the value of the counter reaches the predetermined value, then the first thread may be starved.

In one embodiment of the present invention, a method for detecting and handling the starvation of a thread may comprise the step of setting a counter associated with a first thread with a pre-selected value. The method may further comprise receiving a notification which may indicate which, if any, group of instructions has been completed for the first and second threads. The counter may be updated in response to receiving the notification by changing a current value stored in the counter if the group of instructions is completed for the second thread and not for the first thread. A starvation of the first thread may be detected in response to a value in the counter.

The foregoing has outlined rather broadly the features and technical advantages of one or more embodiments of the present invention in order that the detailed description of the invention that follows may be better understood. Additional features and advantages of the invention will be described hereinafter which form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of a computer system;

FIG. 2 illustrates an embodiment of the present invention of a simultaneous multithreading processor;

FIG. 3 illustrates an example of a thread starvation condition in an SMT processor configured in accordance with an embodiment of the present invention;

FIG. 4 illustrates an embodiment of the present invention of a mechanism for detecting and handling thread starvation conditions; and

FIGS. 5A-B are a flowchart of a method for detecting and handling thread starvation conditions in accordance with an embodiment of the present invention.

### DETAILED DESCRIPTION

The present invention comprises a method and multithread processor for detecting and handling the starvation of a thread. In one embodiment of the present invention, a counter associated with a first thread may be set with a pre-selected value. The counter may be updated in response to receiving a notification. The notification may indicate which, if any, group of instructions has been completed for the first and second threads. The counter may be updated in response to receiving the notification by decrementing a current value stored in the counter if the group of instructions is completed for the second thread and not for the first thread. If the value of the counter reaches a predetermined value, then a thread starvation condition may be detected for the first thread. That is, if the value of the counter reaches the predetermined value, then the first thread may be starved.

Although the present invention is described with reference to a simultaneous multithreading processor, it is noted that the principles of the present invention may be applied to any type of multithreading processor including other types of multithreading, e.g., course grained, fine-grained multithreading. It is further noted that a person of ordinary skill in the art would be capable of applying the principles of the present invention as discussed herein to any type of multithreading processor. It is further noted that embodiments applying the principles of the present invention to any type of multithreading processor would fall within the scope of the present invention.

It is further noted that although the present invention is described with reference to detecting and handling thread starvation conditions among two threads, that the principles of the present invention may be applied to detecting and handling thread starvation conditions among any number of threads. It is further noted that a person of ordinary skill in the art would be capable of applying the principles of the present invention as discussed herein to detecting and handling thread starvation conditions among any number of threads. It is yet further noted that embodiments applying the principles of the present invention discussed herein to detecting and handling thread starvation conditions among any number of threads would fall within the scope of the present invention.

In the following description, numerous specific details are set forth to provide a thorough understanding of the present invention. However, it will be apparent to those skilled in the art that the present invention may be practiced without such specific details. In other instances, well-known circuits may be shown in block diagram form in order not to obscure the present invention in unnecessary detail. For the most part, details considering timing, data formats within communication protocols, and the like have been admitted inasmuch as such details are not necessary to obtain a complete understanding of the present invention and are within the skills of persons of ordinary skill in the relevant art.

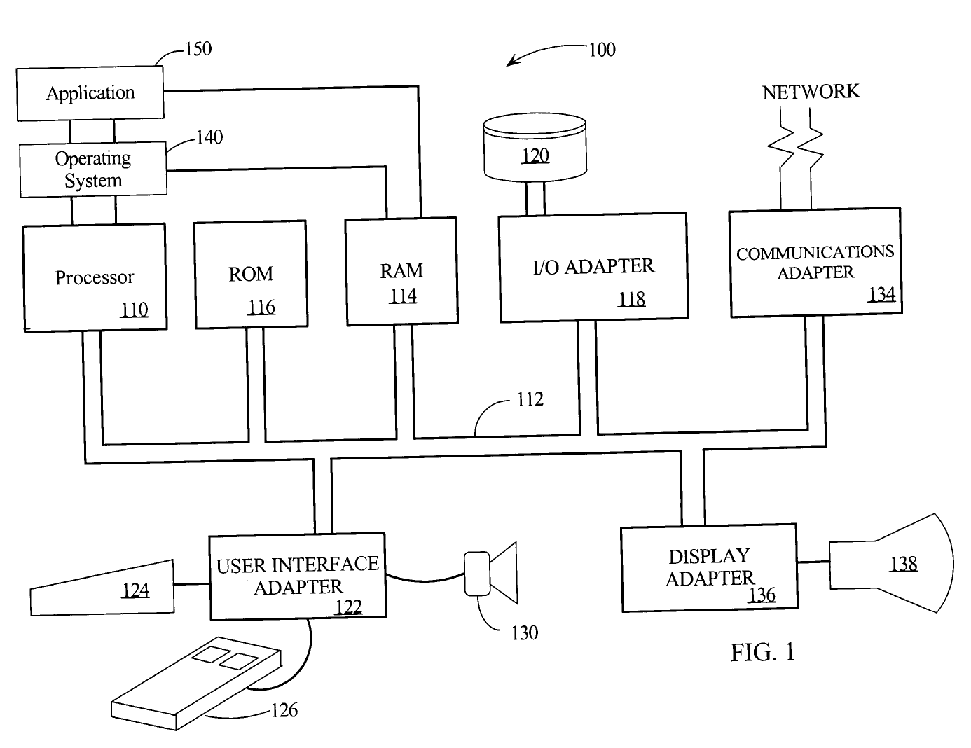

FIG. 1—Computer System

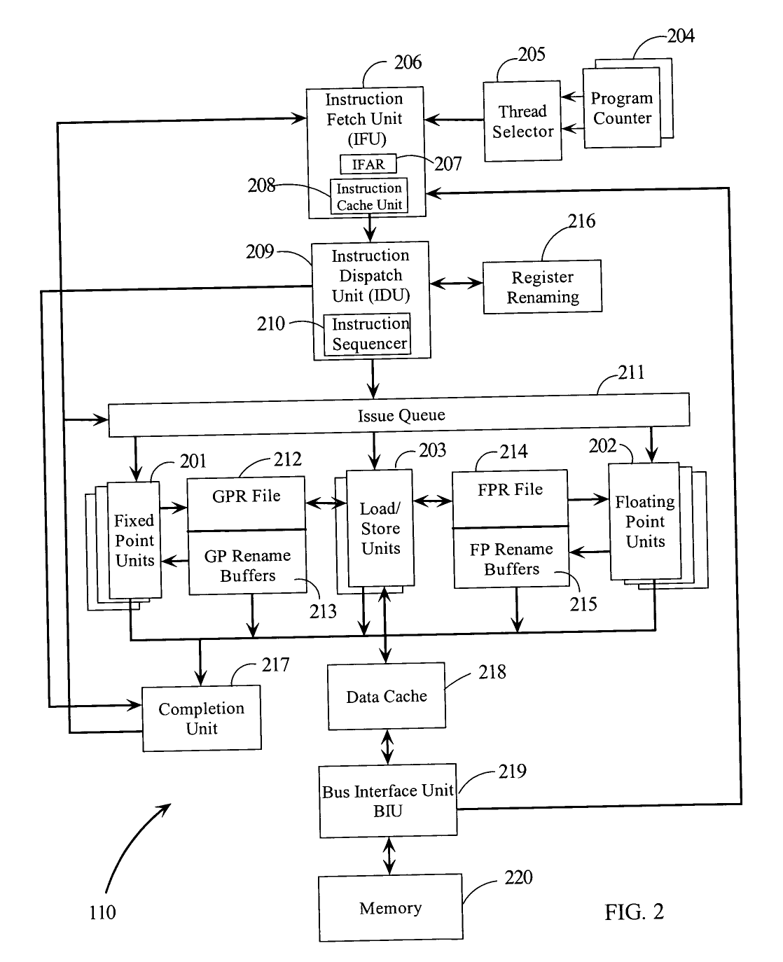

FIG. 1 illustrates a hardware configuration of computer system 100 which is representative of a hardware environment for practicing the present invention. Computer system 100 may have a processing unit 110 coupled to various other components by system bus 112. Processing unit 110 may be a simultaneous multithreading processor as described in detail below in conjunction with FIG. 2. An operating system 140 may run on processor 110 and provide control and coordinate the functions of the various components of FIG. 1. An application 150 in accordance with the principles of the present invention may run in conjunction with operating system 140 and provide calls to operating system 140 where the calls implement the various functions or services to be performed by application 150. Read-Only Memory (ROM) 116 may be coupled to system bus 112 and include a basic input/output system (“BIOS”) that controls certain basic functions of computer system 100. Random access memory (RAM) 114 and disk adapter 118 may also be coupled to system bus 112. It should be noted that software components including operating system 140 and application 150 may be loaded into RAM 114, which may be computer system's 100 main memory for execution. Disk adapter 118 may be an integrated drive electronics (“IDE”) adapter that communicates with a disk unit 120, e.g., a disk drive.

Computer system 100 may further comprise a communications adapter 134 coupled to bus 112. Communications adapter 134 may interconnect bus 112 with an outside network enabling computer system 100 to communicate with other such systems. 1/0 devices may also be connected to system bus 112 via a user interface adapter 122 and a display adapter 136. Keyboard 124, mouse 126 and speaker 130 may all be interconnected to bus 112 through user interface adapter 122. Event data may be inputted to computer system 100 through any of these devices. A display monitor 138 may be connected to system bus 112 by display adapter 136. In this manner, a user is capable of inputting to computer system 100 through keyboard 124 or mouse 126 and receiving output from computer system 100 via display 138.

FIG. 2—Simultaneous Multithreading Processor

FIG. 2 illustrates an embodiment of a simultaneous multithreading processor 110. Multithreading processor 110 may be configured to execute multiple instructions per clock cycle. Further, processor 110 may be configured to simultaneous execute instructions from multiple threads as discussed further below. These instructions may be executed in any of the execution units of processor 110 including Fixed Point Units (FXUs) 201, Floating Point Units (FPUs) 202 and Load/Store Units (LSUs) 203 during any one clock cycle. It is noted that processor 110 may comprise other execution units, such as branch execution units, and that processor 110 is not limited in scope to any one particular embodiment. It is further noted that processor 110 may include additional units, registers, buffers, memories, and other sections than illustrated in FIG. 2. Some of the elements described below, such as issue queues 211, FXUs 201, FPUs 202, LSUs 203, may be referred to either collectively or individually, e.g., FXUs 201, FXU 201. Although processor 110 is described below as executing instructions from two threads, processor 110 may be configured to execute instructions from any number of threads.

Processor 110 may comprise Program Counters (PCs) 204 that correspond to multiple threads, e.g., thread one, thread two, which have instructions for execution. A thread selector 205 may toggle on each clock cycle to select which thread to be executed. Upon selection of a particular thread, an Instruction Fetch Unit (IFU) 206 may be configured to load the address of an instruction from PCs 204 into Instruction Fetch Address Register 207. The address received from PCs 204 may be an effective address representing an address from the program or compiler. The instruction corresponding to the received effective address may be accessed from Instruction Cache (I-Cache) unit 208 comprising an instruction cache (not shown) and a prefetch buffer (not shown). The instruction cache and prefetch buffer may both be configured to store instructions. Instructions may be inputted to instruction cache and prefetch buffer from a system memory 220 through a Bus Interface Unit (BIU) 219.

Instructions from I-Cache unit 208 may be outputted to Instruction Dispatch Unit (IDU) 209. IDU 209 may be configured to decode these received instructions. At this stage, the received instructions are primarily alternating from one thread to another. IDU 209 may further comprise an instruction sequencer 210 configured to forward the decoded instructions in an order determined by various algorithms. The out-of-order instructions may be forwarded to one of a plurality of issue queues 211 where a particular issue queue 211 may be coupled to one or more particular execution units, fixed point units 201, load/store units 203 and floating point units 202. Each execution unit may execute one or more instructions of a particular class of instructions. For example, FXUs 201 may execute fixed point mathematical and logic operations on source operands, such as adding, subtracting, ANDing, ORing and XORing. FPUs 202 may execute floating point operations on source operands, such as floating point multiplication and division. FXUs 201 may input their source and operand information from General Purpose Register (GPR) file 212 and output their results (destination operand information) of their operations for storage at selected entries in General Purpose rename buffers 213. Similarly, FPUs 202 may input their source and operand information from Floating Point Register (FPR) file 214 and output their results (destination operand information) of their operations for storage at selected entries in Floating Point (FP) rename buffers 215.

Processor 110 may dynamically share processor resources, such as execution units, among multiple threads by renaming and mapping unused registers to be available for executing an instruction. This may be accomplished by register renaming unit 216 coupled to IDU 209. Register renaming unit 216 may be configured to determine the registers from the register file, e.g., GPR file 212, FPR file 214, that will be used for temporarily storing values indicated in the instructions decoded by IDU 209.

As stated above, instructions may be queued in one of a plurality of issue queues 211. If an instruction contains a fixed point operation, then that instruction may be issued by an issue queue 211 to any of the multiple FXUs 201 to execute that instruction. Further, if an instruction contains a floating point operation, then that instruction may be issued by an issue queue 211 to any of the multiple FPUs 202 to execute that instruction.

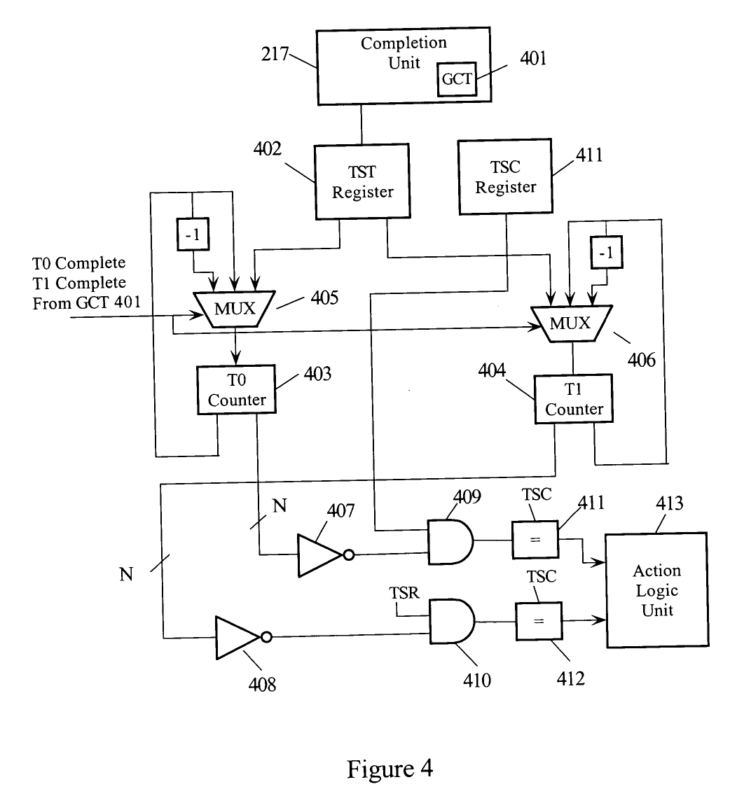

All of the execution units, FXUs 201, FPUs 202, LSUs 203, may be coupled to completion unit 217. Upon executing the received instruction, the execution units, FXUs 201, FPUs 202, LSUs 203, may transmit an indication to completion unit 217 indicating the execution of the received instruction. This information may be stored in a table (not shown) which may then be forwarded to IFU 206. Completion unit 217 may further be coupled to IDU 209. IDU 209 may be configured to transmit to completion unit 217 the status information, e.g., type of instruction, associated thread, of the instructions being dispatched to issue queues 211. Completion unit 217 may further be configured to track the status of these instructions. For example, completion unit 217 may keep track of when these instructions have been “completed.” An instruction may be said to be “completed” when it has executed and is at a stage where any exception will not cause the reissuance of this instruction. Completion unit 217 may further be coupled to issue queues 211 and further configured to transmit an indication of an instruction being completed to the appropriate issue queue 211 that issued the instruction that was completed. Completion unit 217 may further be coupled to instruction sequencer 210 configured to detect and handle thread starvation conditions as discussed further below in conjunction with FIG. 4.

LSUs 203 may be coupled to a data cache 218. In response to a load instruction, LSU 203 inputs information from data cache 218 and copies such information to selected ones of rename buffers 213, 215. If such information is not stored in data cache 218, then data cache 218 inputs through Bus Interface Unit (BIU) 219 such information from a system memory 220 connected to system bus 112 (see FIG. 1). Moreover, data cache 218 may be able to output through BIU 219 and system bus 112 information from data cache 218 to system memory 220 connected to system bus 112. In response to a store instruction, LSU 203 may input information from a selected one of GPR 212 and FPR 214 and copies such information to data cache 218.

It is noted that processor 110 may comprise any number of execution units, e.g., FXUs 201, FPUs 202, LSUs 203, any number of issue queues 211, program counters 201 representing threads, GPRs 212 and FPRs 214, and that processor 110 is not to be confined in scope to any one particular embodiment.

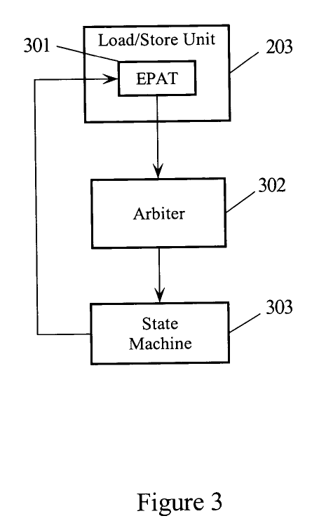

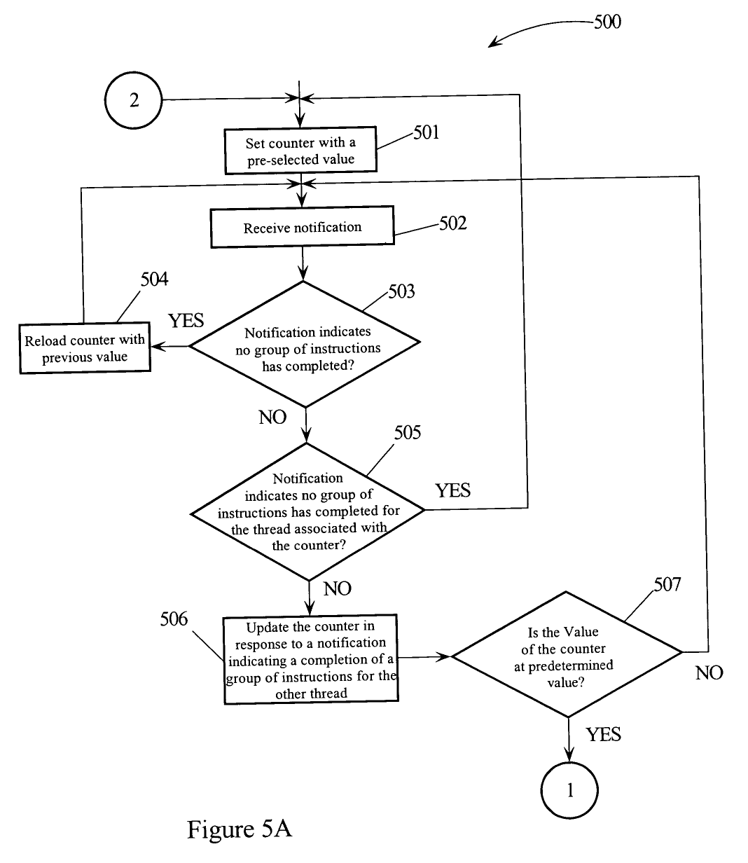

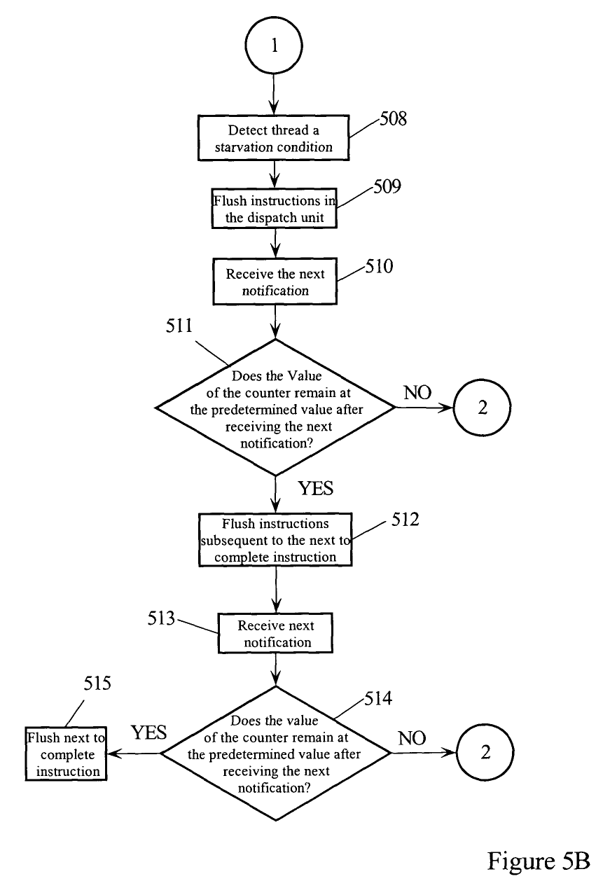

As stated in the Background Information section, the current techniques for detecting and handling thread starvation conditions usually involve a counter counting the number of cycles from the last instruction executed for the thread starved. If the number exceeds a threshold, then a starvation of a thread may be assumed. Typically, the threshold is extremely high, such as on the order of a million cycles, to ensure that a thread starvation condition is not incorrectly identified such as identifying the fetching of an instruction from memory after a cache miss as a thread starvation condition. Further, the current recovery methods for a thread being starved usually involve a flush of all of the stored instructions for all threads and to refetch the instruction causing the thread starvation condition. These techniques for detecting thread starvation conditions are too slow. Further, flushing of all instructions should be avoided if at all possible. Therefore, there is a need in the art to effectively detect and handle thread starvation conditions in a simultaneous multithreading (SMT) processor by detecting thread starvation conditions earlier than current detection techniques and avoiding the flushing of all instructions in a recovery action. FIG. 3 illustrates an example of a thread starvation condition in SMT processor 110. FIG. 4 illustrates an embodiment of the present invention of a mechanism in instruction sequencer 210 for detecting thread starvation conditions earlier than current detection techniques and avoiding the flushing of all instructions in a recovery action. FIGS. 5A-B are a flowchart of a method for detecting thread starvation conditions earlier than current detection techniques and avoiding the flushing of all instructions in a recovery action using the mechanism described in FIG. 4.

FIG. 3—Example of a Thread Starvation in SMT Processor

FIG. 3 illustrates an example of a thread starvation in processor 110 in accordance with an embodiment of the present invention. Referring to FIG. 3, FIG. 3 illustrates LSU 203 comprising an Effective to Real Address Translation (ERAT) table 301. ERAT table 301 may be configured to translate an effective address, i.e., an address of a program or compiler, to a real address, i.e., an address in physical memory. ERAT table 301 may be configured to store the most recently used address translations, i.e., most recently used translations of effective addresses to real addresses. LSU 203 may receive a load instruction for a particular thread, e.g., thread 0 (thread T₀), from an issue queue 211 coupled to LSU 203. LSU 203 may retrieve the address (effective address) of the load instruction from GPR 212. The effective address may indicate the location to fetch the data requested. LSU 203 may be configured to search ERAT table 301 for the real address corresponding to the effective address retrieved. If ERAT table 301 does not contain the translation of the effective address retrieved, then LSU 203 may be configured to transmit a request to arbiter 302 to obtain access to state machine 303 to obtain the real address corresponding to the effective address received. State machine 303 may be configured to determine the real address corresponding to the effective address retrieved by LSU 203 by searching various memory structures in processor 110. Upon state machine 303 obtaining the real address corresponding to the effective address retrieved by LSU 203, ERAT table 301 may be reloaded with this information by state machine 303.

As stated above, LSU 203 may be configured to transmit a request to arbiter 302 to obtain access to state machine 303. Arbiter 302 may deny the request if state machine 303 is currently being used to service another thread, e.g., thread 1 (thread T₁). If arbiter 302 denies the request to access state machine 303, LSU 203 may retransmit the request after a period of time, e.g., seven clock cycles. However, arbiter 302 may deny the retransmitted request if state machine 303 is not available, i.e., if state machine 303 is servicing another thread. If arbiter 302 continually denies the request to access state machine 303, then the thread, e.g., thread T₀, associated with the continually denied request may be starved. That is, the thread, e.g., thread T₀, associated with the load instruction to be serviced may be starved as state machine 303 is being exclusively used by another thread(s). The starvation of a thread may be detected and handled using the mechanism described below in conjunction with FIG. 4.

FIG. 4—Mechanism for Detecting and Handling Thread Starvation Conditions

FIG. 4 illustrates an embodiment of the present invention of a mechanism in instruction sequencer 210 (see FIG. 2) for detecting and handling thread starvation conditions. Referring to FIG. 4, completion unit 217 (see FIG. 2) may be configured to track the status, e.g., type of instruction, associated thread, completion of instruction, of instructions being dispatched to issue queues 211 (see FIG. 2) by IDU 209 (see FIG. 2). In one embodiment, completion unit 217 may be configured to track the status of the instructions in groups. For example, completion unit 217 may track the status of groups of instructions, e.g., group of eight instructions, per thread. In one embodiment, completion unit 217 may comprise a table 401, referred to herein as the “Group Completion Table (GCT)”, configured to track the completion of a group of instructions per thread, e.g., thread T₀, thread T₁. A group of instructions may be said to be “completed” when they have executed and are at a stage where an exception will not cause the re-issuance of any of the instructions in the group of instructions.

Completion unit 217 may be coupled to instruction sequencer 210 configured to detect and handle thread starvation conditions as discussed below. Completion unit 217 may be coupled to a register 402 in instruction sequencer 210, referred to herein as the “Thread Switch Time-out (TST) register,” configured to store a pre-selected value, e.g., 1,024.

Instruction sequencer 210 may further comprise thread T₀ counter 403, thread T₁ counter 404 coupled to TST register 402 via multiplexer 405, multiplexer 406, respectively. T₀ counter 403 may be configured to count downwards from the pre-selected value stored in TST register 402 the number of times the group of instructions for the other thread, thread T₁, has consecutively completed without a completion of a group of instructions for thread T₀. Similarly, T₁ counter 404 may be configured to count downwards from the pre-selected value stored in TST register 402 the number of times the group of instructions for the other thread, thread T₀, has consecutively completed without a completion of a group of instructions for thread T₁.

As stated above, multiplexer 405, 406 may be coupled to counters 403, 404, respectively. GCT 401 may transmit an indication as to which, if any, group of instructions for thread T₀ and thread T₁ has been completed in the last clock cycle to a select line in multiplexers 405, 406. Based on this indication, multiplexer 405 may be configured to select either the pre-selected value, e.g., 1,024, stored in TST register 402, the value currently stored in T₀ counter 403 or the value currently stored in T₀ counter 403 minus the value of “1”, to be loaded in T₀ counter 403. Similarly, based on this indication, multiplexer 406 may be configured to select either the pre-selected value, e.g., thousand, stored in TST register 402, the value currently stored in T₁ counter 404 or the value currently stored in T₁ counter 404 minus the value of “1”, to be loaded in T₁ counter 404.

If GCT 401 transmitted an indication to multiplexer 405, 406 indicating that a group of instructions has not been completed for either thread T₀, thread T₁, then counter 403, 404, respectively, is reloaded with the previous value stored in counter 403, 404, respectively. For example, if multiplexer 405 received a notification that indicated that a group of instructions has not been completed for either thread, then counter 403 is reloaded with the previous value stored in counter 403. Similarly, if multiplexer 406 received a notification that indicated that a group of instructions has not been completed for either thread, then counter 404 is reloaded with the previous value stored in counter 404.

If GCT 401 transmitted an indication to multiplexer 405, 406 indicating that a group of instructions has been completed for the thread associated with counter 403, 404, respectively, or for both threads, then counter 403, 404, respectively, is loaded with the pre-selected value stored in TST register 402. For example, if multiplexer 405 received a notification indicating that a group of instructions has been completed for thread T₀ or for both threads T₀ and T₁, then counter 403 is loaded with the pre-selected value stored in TST register 402 in step 501. Similarly, if multiplexer 406 received a notification indicating that a group of instructions has been completed for thread T₁ or for both threads T₀ and T₁, then counter 404 is loaded with the pre-selected value stored in TST register 402 in step 501.

If GCT 401 transmitted an indication to multiplexer 405, 406 indicating that a group of instructions has been completed for only the other thread, then the value in counter 403, 404, respectively, may be updated by decrementing the current value stored in counter 403, 404, respectively. In one embodiment, the current value stored in counter 403, 404 may be decremented by the value of one. For example, if multiplexer 405 received a notification indicating that a group of instructions has been completed only for thread T₁, then the value in counter 403 may be updated by decrementing the current value stored in counter 403 by the value of “1.” Similarly, if multiplexer 406 received a notification indicating that a group of instructions has been completed only for thread T₀, then the value in counter 404 may be updated by decrementing the current value stored in counter 404 by the value of “1.”

The output of counters 403, 404 (N bits of data), e.g., 10 bit number, may be inputted to NOR gates 407, 408, respectively, whose output may be inputted to AND gates 409, 410, respectively. AND gates 409, 410 may further receive as input, the value stored in register 411, referred to herein as the “Thread Switch Control (TSC) register.” In this embodiment of the present invention, TSC register 411 stores the logical value of “1.”

When the output of counters 403, 404, equals 0, then the output of NOR gate 407, 408, respectively, is the logical value of “1.” Hence, the output of AND gate 409, 410 is equal to the logical value of “1” when the output of counters 403, 404 is equal to 0, respectively, since in this embodiment of the present invention, TSC register 411 stores the logical value of “1.”

The outputs of AND gates 409, 410 are compared with the value stored in TSC register 411 by comparators 411, 412, respectively. The output of comparators 411, 412 are inputted to action logic unit 413 configured to implement a recovery action upon comparator 411, 412 detecting a thread starvation condition. A more detailed description of the recovery action implemented by action logic unit 413 is discussed further below in conjunction with FIGS. 5A-B.

If the output of AND gate 409, 410 is equal to the value stored in TSC register 411, then comparator 411, 412, respectively, may output a signal, e.g., a logical value of “1,” to activate action logic unit 413 to implement a recovery action. In one embodiment, TSC register 411 may store a logical value of “1.” As stated above, the output of AND gate 409, 410 may be a logical value of “1” when the output of counters 403, 404 is equal to 0. Counter 403 may store the value of “0” when X (represent the value stored in TST register 402) groups of instructions for thread T₁ have been completed consecutively without a group of instruction for thread T₀ having been completed. When counter 403 stores a value of “0”, this may indicate that thread T₀ has been starved. That is, thread T₀ cannot make forward progress because of a resource, e.g., state machine 303 (see FIG. 3), being used exclusively by another thread, e.g., thread T₁. Similarly, counter 404 may store a value of “0” when X (represent the value stored in TST register 402) groups of instructions for thread T₀ have been completed consecutively without a group of instruction for thread T₁ having been completed. When counter 404 stores a value of “0”, this may indicate that thread T₁ has been starved. That is, thread T₁ cannot make forward progress because of a resource, e.g., state machine 303, being used exclusively by another thread, e.g., thread T₀.

By using the above described mechanism, thread starvation conditions may be detected earlier than in prior art. Thread starvation conditions may be detected earlier than in prior art, in part, by using a notification from GCT table 401 indicating if a group of instructions has been completed for a thread to determine how the value of a counter should be updated instead of counting the number of cycles from the last instruction executed for a thread. The threshold is not extremely high, such as on the order of a million cycles, but instead may be on the order of a thousand.

It is noted that the circuitry of instruction sequencer 210 described above is illustrative and that other circuitry may be used to accomplish the functions described above. It is further noted that embodiments incorporating such other circuitry would fall within the scope of the present invention. It is further noted that even though the above describes detecting a thread starvation condition when counter 403, 404 reaches a value of zero that the thread starvation condition may be detected upon counter 403, 404 reaching any predetermined value.

FIGS. 5A-B—Method for Detecting and Handling A Starvation of a Thread

FIGS. 5A-B are a flowchart of one embodiment of the present invention of a method 500 for detecting and handling a starvation of a thread.

Referring to FIG. 5A, in conjunction with FIGS. 2-4, in step 501, counter 403, 404 is set with a pre-selected value stored in TST register 402. In step 502, multiplexer 405, 406 receives a notification from GCT 401. The notification may indicate which, if any, group of instructions has been completed for thread T₀ and thread T₁.

In step 503, a determination is made by multiplexer 405,406 as to whether it received a notification indicating that a group of instructions has not been completed for either thread. If multiplexer 405,406 received a notification that indicated that a group of instructions has not been completed for either thread, then, in step 504, counter 403, 404, respectively, is reloaded with the previous value stored in counter 403, 404, respectively. For example, if multiplexer 405 received a notification that indicated that a group of instructions has not been completed for either thread, then counter 403 is reloaded with the previous value stored in counter 403. Similarly, if multiplexer 406 received a notification that indicated that a group of instructions has not been completed for either thread, then counter 404 is reloaded with the previous value stored in counter 404. Upon reloading counter 403, 404, multiplexer 405, 406, respectively, receives another notification from GCT 401 in step 502.

If, however, multiplexer 405, 406 did not receive a notification indicating that a group of instructions has not been completed for either thread, then, in step 505, a determination is made by multiplexer 405, 406 as to whether it received a notification indicating that a group of instructions has been completed for the thread associated with counter 403, 404, respectively. For example, multiplexer 405 determines whether it received a notification indicating that a group of instructions has been completed for thread T₁ or for both threads T₀ and T₁. Multiplexer 406 determines whether it received a notification indicating that a group of instructions has been completed for thread T₀ or for both threads T₀ and T₁.

If the group of instructions is completed for the thread associated with counter 403, 404, then counter 403, 404 is loaded with the pre-selected value stored in TST register 402 in step 501. For example, if multiplexer 405 received a notification indicating that a group of instructions has been completed for thread T₀ or for both threads T₀ and T₁, then counter 403 is loaded with the pre-selected value stored in TST register 402 in step 501. Similarly, if multiplexer 406 received a notification indicating that a group of instructions has been completed for thread T₁ or for both threads T₀ and T₁, then counter 404 is loaded with the pre-selected value stored in TST register 402 in step 501.

If, however, the notification indicated that a group of instructions has been completed only for the other thread, then in step 506, the value in counter 403, 404 is updated by decrementing current value stored in counter 403, 404. In one embodiment, the current value stored in counter 403, 404 may be decremented by the value of “1.” For example, if multiplexer 405 received a notification indicating that a group of instructions has been completed for thread T₁, then the value in counter 403 is updated by reducing the current value stored in counter 403 by the value of “1.” Similarly, if multiplexer 406 received a notification indicating that a group of instructions has been completed for thread T₀, then the value in counter 404 is updated by reducing the current value stored in counter 404 by the value of “1.”

In step 507, a determination is made as to whether the value in counter 403, 404 is equal to a predetermined value, e.g., zero. If the value of counter 403, 404 is not equal to the predetermined value, then multiplexer 405, 406, respectively, receives another notification from GCT 401 in step 502. For example, if the value of counter 403 is not equal to the predetermined value, then multiplexer 405 receives another notification from GCT 401 in step 502. Similarly, if the value of counter 404 is not equal to the predetermined value, then multiplexer 406 receives another notification from GCT 401 in step 502.

Referring to FIG. 5B, in conjunction with FIGS. 2-4, if, however, the value in counter 403, 404 is equal to the predetermined value, then a thread starvation condition is detected in step 508. For example, if the value in counter 403 is equal to the predetermined value, then a starvation of a thread T₀ is detected. Similarly, if the value in counter 404 is equal to the predetermined value, then thread T₁ may be starved. As stated above, a thread starvation condition may be detected when the output of AND gate 409, 410 is equal to the value stored in TSC register 411. This may occur when the value of counter 403, 404, respectively is equal to the predetermined value of zero. Counter 403 may store the value of zero when X (represent the value stored in TST register 402) groups of instructions for thread T₁ have been completed consecutively without a group of instruction for thread T₀ having been completed. When counter 403 stores a value of “0”, this may indicate that thread T₀ has been starved. That is, thread T₀ cannot make forward progress because of a resource, e.g., state machine 303 (see FIG. 3), being used exclusively by another thread, e.g., thread T₁. Similarly, counter 404 may store a value of “0” when X (represent the value stored in TST register 402) groups of instructions for thread T₀ have been completed consecutively without a group of instruction for thread T₁ having been completed. When counter 404 stores a value of “0”, this may indicate that thread T₁ has been starved. That is, thread T₁ cannot make forward progress because of a resource, e.g., state machine 303, being used exclusively by another thread, e.g., thread T₀.

As stated above, upon detection of a thread starvation condition, action logic unit 413 may implement a recovery action to handle the thread starvation condition. Instead of flushing all the instructions for all the threads as in prior art, action logic unit 413 may implement a recovery action in a tiered fashion thereby not necessarily flushing all the instructions for the thread causing the thread starvation condition unless necessary as described below.

In step 509, action logic unit 413 implements a first tier of the recovery action involving the flushing of instructions in IDU 209 upon the detection of a thread starvation condition.

In step 510, multiplexer 405, 406, associated with the starved thread, receives another notification from GCT 401.

A determination is made in step 511 as to whether the value of counter 403, 404, associated with the starved thread, remains at the predetermined value, e.g., zero, after multiplexer 405, 406, respectively, associated with the starved thread, receives the next notification from GCT 401 in step 510. For example, if thread T₀ was detected as being starved, then a determination is made as to whether the value in counter 403 remains at the predetermined value after multiplexer 405 receives the next notification from GCT 401 in step 510. Similarly, if thread Ti is detected as being starved, then a determination is made as to whether the value remains at the predetermined value in counter 404 after multiplexer 406 receives the next notification from GCT 401 in step 510.

If the value of counter 403, 404 does not remain at the predetermined value after multiplexer 405, 406, respectively, receives the next notification from GCT 401 in step 510, then, counter 403, 404, respectively, is loaded with a pre-selected value stored in TST register 402 in step 501. If this occurs, then the thread that was starved is now making forward progress because the resource, e.g., state machine 303 (see FIG. 3), is no longer being exclusively used by the other thread. For example, if thread T₀ was detected as being starved, then instructions of thread T₁ in IDU 209 may be flushed. If the value in counter 403 does not remain at the predetermined value after multiplexer 405 receives the next notification from GCT 401 in step 510, then thread T₀ is no longer starved from making forward progress because the resource, e.g., state machine 303, is no longer being exclusively used by thread T₁. Similarly, if thread T₁ was detected as being starved, then instructions of thread T₀ in IDU 209 may be flushed. If the value in counter 404 does not remain at the predetermined value after multiplexer 406 receives the next notification from GCT 401 in step 510, then thread T₁ is no longer starved from making forward progress because the resource, e.g., state machine 303, is no longer being exclusively used by thread T₀.

If, however, the value of counter 403, 404, associated with the thread detected as being starved, remains at the predetermined value after multiplexer 405, 406, respectively, receives the next notification from GCT 401 in step 510, then, in step 512, action logic unit 413 implements the second tier of the recovery action involving the flushing of instructions subsequent to the “next to complete instruction” for the thread causing the other thread to be starved. As stated above, an instruction may be said to be completed when it has executed and it is at a stage where any exception will not cause the reissuance of this instruction. The “next to complete instruction” is the instruction following the completed instruction with the highest priority to be executed. For example, if thread T₀ was detected as being starved and the value of counter 403 remained at the predetermined value after multiplexer 405 received the next notification from GCT 401 in step 510, then instructions subsequent to the next to complete instruction for thread T₁ may be flushed. Similarly, if thread T₁ was detected as being starved and the value of counter 404 remained at the predetermined value after multiplexer 406 received the next notification from GCT 401 in step 510, then instructions subsequent to the “next to complete instruction” for thread T₀ may be flushed.

In step 513, multiplexer 405, 406, associated with the starved thread, receives another notification from GCT 401.

A determination in made in step 514 as to whether the value of counter 403, 404, associated with the starved thread, remains at the predetermined value, e.g., zero, after multiplexer 405, 406, respectively, associated with the starved thread, receives the next notification from GCT 401 in step 513. For example, if thread T₀ was detected as being starved, then a determination is made as to whether the value in counter 403 remains at the predetermined value after multiplexer 405 receives the next notification from GCT 401 in step 513. Similarly, if thread T₁ is detected as being starved, then a determination is made as to whether the value remains at the predetermined value in counter 404 after multiplexer 406 receives the next from GCT 401 in step 513.

If the value of counter 403, 404 does not remain at the predetermined value after multiplexer 405, 406, respectively, receives the next notification from GCT 401 in step 513, then, counter 403, 404, respectively, is loaded with a pre-selected value stored in TST register 402 in step 501. If this occurs, then the thread that was starved is now making forward progress because the resource, e.g., state machine 303 (see FIG. 3), is no longer being exclusively used by the other thread.

If, however, the value of counter 403, 404, associated with the thread detected as being starved, remains at the predetermined value, e.g., zero, after multiplexer 405, 406, respectively, receives the next notification from GCT 401 in step 513, then, in step 515, action logic unit 413 implements the third tier of the recovery action involving the flushing of the “next to complete instruction.” For example, if thread T₀ was detected as being starved and the value of counter 403 remained at the predetermined value after multiplexer 405 received the next notification from GCT 401 in step 513, then the “next to complete instruction” for thread T₁ may be flushed. Similarly, if thread T₁ was detected as being starved and the value of counter 404 remained at the predetermined value after multiplexer 406 received the next notification from GCT 401 in step 513, then the “next to complete instruction” for thread T₀ may be flushed.

It is noted that method 500 may include other and/or additional steps that, for clarity, are not depicted. It is noted that method 500 may be executed in a different order presented and that the order presented in the discussion of FIGS. 5A-B are illustrative. It is further noted that certain steps in method 500 may be executed in a substantially simultaneous manner.

Although the method and multithreaded processor are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for detecting and handling the starvation of a thread in a multithreading processor comprising the steps of:
setting a counter associated with a first thread with a pre-selected value;
receiving a first notification, wherein said first notification indicates which, if any, group of instructions has been completed for said first and a second thread;
updating said counter in response to receiving said first notification, wherein said counter is updated in response to receiving said first notification by changing a current value stored in said counter if said group of instructions is completed for said second thread and not for said first thread; and
detecting a starvation of said first thread in response to a value in said counter.

2. The method as recited in claim 1, wherein said current value in said counter is changed by decrementing said current value by a value of one if said group of instructions is completed for said second thread and not for said first thread.

3. The method as recited in claim 2, wherein said starvation of said first thread is detected if said value of said counter is a predetermined value, wherein said predetermined value is zero.

4. The method as recited in claim 1 further comprising the step of:
reloading said counter with a previous value stored in said counter if said first notification indicates that a group of instructions has not been completed for either of said first thread and said second thread.

5. The method as recited in claim 1 further comprising the step of:
loading said counter with said pre-selected value if said first notification indicates a group of instructions is completed for said first thread.

6. The method as recited in claim 1 further comprising the step of:
receiving a second notification if said value of said counter is not zero.

7. The method as recited in claim 1 further comprising the step of:
flushing instructions of said second thread in a dispatch unit.

8. The method as recited in claim 7 further comprising the step of:
determining if said value of said counter remains at zero after receiving a second notification indicating which, if any, group of instructions has been completed for said first thread and said second thread.

9. The method as recited in claim 8 further comprising the step of:
flushing instructions of said second thread subsequent to a next to complete instruction of said second thread if said value of said counter remained at zero after receiving said second notification.

10. The method as recited in claim 9 further comprising the step of:
determining if said value of said counter remains at zero after receiving a third notification indicating which, if any, group of instructions has been completed for said first thread and said second thread.

11. The method as recited in claim 10 further comprising the step of:
flushing said next to complete instruction of said second thread if said value of said counter remained at zero after receiving said third notification.

12. A multithreading processor, comprising:
a dispatch unit;
a queue coupled to said dispatch unit, wherein said dispatch unit is configured to dispatch decoded instructions for a first thread and a second thread to said queue; and
a completion unit coupled to said queue, wherein said completion unit is configured to receive status information on said dispatched decoded instructions to said queue, wherein said completion unit comprises:
a group completion table configured to track when a group of instructions for said first thread and said second thread is completed,
wherein said dispatch unit comprises:
a register coupled to said completion unit configured to store a pre-selected value;
a counter associated with said first thread coupled to said register;
logic for setting said counter with said pre-selected value;
logic for receiving a first notification from said group completion table, wherein said first notification indicates which, if any, group of instructions has been completed for said first and said second thread;
logic for updating said counter in response to receiving said first notification by changing a current value stored in said counter if said group of instructions is completed for said second thread and not for said first thread; and
logic for detecting a starvation of said first thread in response to a value in said counter.

13. The multithreading processor as recited in claim 12, wherein said current value in said counter is changed by decrementing said current value by a value of one if said group of instructions is completed for said second thread and not for said first thread.

14. The multithreading processor as recited in claim 13, wherein said starvation of said first thread is detected if said value of said counter is a predetermined value, wherein said predetermined value is zero.

15. The multithreading processor as recited in claim 12, wherein said dispatch unit further comprises:
logic for reloading said counter with a previous value stored in said counter if said first notification indicates that a group of instructions has not been completed for either of said first thread and said second thread.

16. The multithreading processor as recited in claim 12, wherein said dispatch unit further comprises:
logic for loading said counter with said pre-selected value if said first notification indicates a group of instructions is completed for said first thread.

17. The multithreading processor as recited in claim 12, wherein said dispatch unit further comprises:
logic for receiving a second notification if said value of said counter is not zero.

18. The multithreading processor as recited in claim 12, wherein said dispatch unit further comprises:
logic for flushing instructions of said second thread in said dispatch unit.

19. The multithreading processor as recited in claim 18, wherein said dispatch unit further comprises:
logic for determining if said value of said counter remains at zero after receiving a second notification indicating which, if any, group of instructions has been completed for said first thread and said second thread.

20. The multithreading processor as recited in claim 19, wherein said dispatch unit further comprises:
logic for flushing instructions of said second thread subsequent to a next to complete instruction of said second thread if said value of said counter remained at zero after receiving said second notification.

21. The multithreading processor as recited in claim 20, wherein said dispatch unit further comprises:
logic for determining if said value of said counter remains at zero after receiving a third notification indicating which, if any, group of instructions has been completed for said first thread and said second thread.

22. The multithreading processor as recited in claim 21, wherein said dispatch unit further comprises:
logic for flushing said next to complete instruction of said second thread if said value of said counter remained at zero after receiving said third notification.
